(19) United States
(12) Patent Application Publication
(10) Pub. No.: US 2011/0156719 A1
(43) Pub. Date: Jun. 30, 2011

(54) ELECTRICAL INSULATION TEST APPARATUS

(75) Inventors: Hsin-Wei Huang, Yilan County (TW); Man-Chit Wong, Hong Kong (HK); Chen-Yu Yang, Keelung City (TW); Tze-Kin Yuen, Honk Kong (HK)

(73) Assignee: Du Pont Apollo Limited, Hong Kong (HK)

(21) Appl. No.: 12/955,204

(22) Filed: Nov. 29, 2010

Related U.S. Application Data
(60) Provisional application No. 61/291,571, filed on Dec. 31, 2009.

(51) Int. Cl. H01H 31/12

(52) U.S. Cl. 324/551

(57) ABSTRACT

An electrical insulation test apparatus includes a cap having an indentation, and a conductive cushion arranged in the indentation. The conductive cushion has a receiving space sized to meet a tested photovoltaic panel. Since the conductive cushion is deformable, the conductive cushion will deform upon the size of the tested photovoltaic panel for completely contacting with peripheral surfaces of the tested photovoltaic panel when the tested photovoltaic panel is in the receiving space.

### RELATED APPLICATIONS

This application claims priority to U.S. Provisional Application Ser. No. 61/291,571, filed Dec. 31, 2009, which is herein incorporated by reference.

### BACKGROUND

1. Technical Field

The invention relates to an electrical insulation test apparatus, more particularly to an electrical insulation test apparatus of a photovoltaic panel.

2. Description of Related Art

Refer to FIG. 1 in which FIG. 1 illustrates a conventional electrical insulation test for a photovoltaic panel. The conventional electrical insulation test for a photovoltaic panel 10 is to wrap some conductive foil papers 12 on all edges of the photovoltaic panel 10 first, and then to electrically connect the conductive foil papers 12 to an electric conductivity testing device 20.

After a junction box 11 is electrically conducted with an interior of the photovoltaic panel 10, if the electric conductivity testing device 20 can be electrically conducted from the photovoltaic panel 10 via the conductive foil papers 12, electric leakages might occur to at least one edge of the photovoltaic panel 10; otherwise, if the electric conductivity testing device 20 cannot be electrically conducted from the photovoltaic panel 10 via the conductive foil papers 12, the edges of the photovoltaic panel 10 might be electrically insulated from the interior of the photovoltaic panel 10.

However, since the conductive foil papers 12 are easy to wrinkle when wrapping on the edges of the photovoltaic panel 10, the wrinkled conductive foil papers 12 are not able to reuse for next time. Thus, using conductive foil papers 12 for contacting the edges of the photovoltaic panel 10 will increase material costs for purchasing new conductive foil papers 12 each time, and labor costs for wrapping them on the photovoltaic panel 10 by manpower each time.

In addition, since the conductive foil papers 12 are easy to wrinkle when wrapping on the edges of the photovoltaic panel 10, gaps 13 might exist between the surface of the photovoltaic panel 10 and the conductive foil papers 12. Therefore, a partial surface of the photovoltaic panel 10 corresponding to the gap 13 might not be able to electrically contact with the conductive foil papers 12. Thus, the conductive foil papers 12 cannot completely contact the surfaces of the edges of the photovoltaic panel 10, so that the result of the conventional electrical insulation test could be incorrect.

Furthermore, when the conductive foil papers 12 are wrapped on the edges of the photovoltaic panel 10, the conductive foil papers 12 might scratch the photovoltaic panel 10 to damage the surface of the photovoltaic panel 10.

Therefore, an improved solution other than the conventional way needs to be provided to overcome the problems and inconveniences mentioned above.

### SUMMARY

One objective of the present invention is to provide an electrical insulation test apparatus, which can be reusable in testing electric conductivity of a plurality of photovoltaic panels. Thus, the present invention is unnecessary to wrap the photovoltaic panel by conductive foil papers so as to decrease the material costs and the labor costs.

Another objective of the present invention is to provide an electrical insulation test apparatus, which is able to contact surfaces of edges of a photovoltaic panel as completely as possible. Thus, gaps between the electrical insulation test apparatus and the surfaces of the photovoltaic panel will be effectively decreased, so that the result of the electrical insulation test might be much more correct.

The other objective of the present invention is to provide an electrical insulation test apparatus, which is able to protect the surfaces of a photovoltaic panel from being scratched when the photovoltaic panel is in the test.

To achieve these and other advantages and in accordance with the objective of the present invention, as the embodiment broadly describes herein, an electrical insulation test apparatus for testing electric conductivity of a photovoltaic panel is provided. The electrical insulation test apparatus includes a cap having an indentation at one side thereof, and a conductive cushion installed in the indentation. The conductive cushion has a receiving space substantially sized to fit a size of the tested photovoltaic panel. Thus, since the conductive cushion is deformable, the conductive cushion will contact with peripheral surfaces of the tested photovoltaic panel as completely as possible when the tested photovoltaic panel is moved in the receiving space.

In addition, the cap has a plurality of inner sidewalls surrounding the indentation thereof, and the conductive cushion is coupled to the inner sidewalls of the cap.

In one embodiment, the cap is rigid enough so that the cap is unable to be bended while the tested photovoltaic panel is moved in the receiving space. Thus, it helps the conductive cushion to contact with the peripheral surfaces of the tested photovoltaic panel tightly. Also, the cap can be made of metal, plastic, glass or wood etc.

In another embodiment, the cap is presented as a rectangular shape, and the receiving space of the conductive cushion is presented as a rectangular shape.

In the other embodiment, the conductive cushion is formed integrally in one piece shown as a rectangular ring, or the conductive cushion comprises a plurality of components assembled together. Furthermore, the conductive cushion can be a conductive foam, a conductive gel, a conductive adhesive or a conductive resin etc.

In the other embodiment, a movable arm physically connected with the cap is provided for carrying the electrical insulation test apparatus towards the photovoltaic panel.

In another aspect of the present invention, the present invention provides an electrical insulation test apparatus for testing electric conductivity of a photovoltaic panel. The electrical insulation test apparatus includes a conductive and deformable member and an electric conductivity testing device, and the conductive and deformable member is operable for surrounding the tested photovoltaic panel to being deformed to fit the size of the tested photovoltaic panel so as to completely contact all peripheral surfaces of the tested photovoltaic panel. The electric conductivity testing device is electrically connected with the conductive and deformable member, for detecting whether the peripheral surfaces of the tested photovoltaic panel are electrically conducted with the conductive and deformable member.

In one embodiment, the conductive and deformable member can be made of a conductive foam, a conductive gel, a conductive adhesive or a conductive resin etc.

In another embodiment, the conductive and deformable member having a receiving space is substantially sized to fit a size of the tested photovoltaic panel.

In another embodiment, the electrical insulation test apparatus further includes a cap having an indentation at one side thereof. The conductive and deformable member is installed in the indentation thereof and is carried by the cap.

In another embodiment, the cap is rigid enough so that the cap is unable to be bended while the tested photovoltaic panel is moved in the receiving space.

In another embodiment, the cap can be made of metal, plastic, glass or wood etc.

Accordingly, the electrical insulation test apparatus according to the present invention effectively contacts all peripheral surfaces of the tested photovoltaic panel as completely as possible, so as to increase the correctness of the result of the electrical insulation test. In addition, unlike wrapping conductive foil papers, the electrical insulation test apparatus can be reusable in testing electric conductivity of the photovoltaic panels so as to decrease the material costs and the labor costs.

### BRIEF DESCRIPTION OF THE DRAWINGS

FIG. 1 illustrates a conventional electrical insulation test for a photovoltaic panel.

FIG. 2 illustrates a disassembling view of an electrical insulation test apparatus with a photovoltaic panel according to one embodiment of the present invention.

FIG. 3 illustrates a bottom view of the electrical insulation test apparatus in FIG. 2.

FIG. 4 illustrates a cross-sectional view of the electrical insulation test apparatus according to another embodiment of the present invention.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

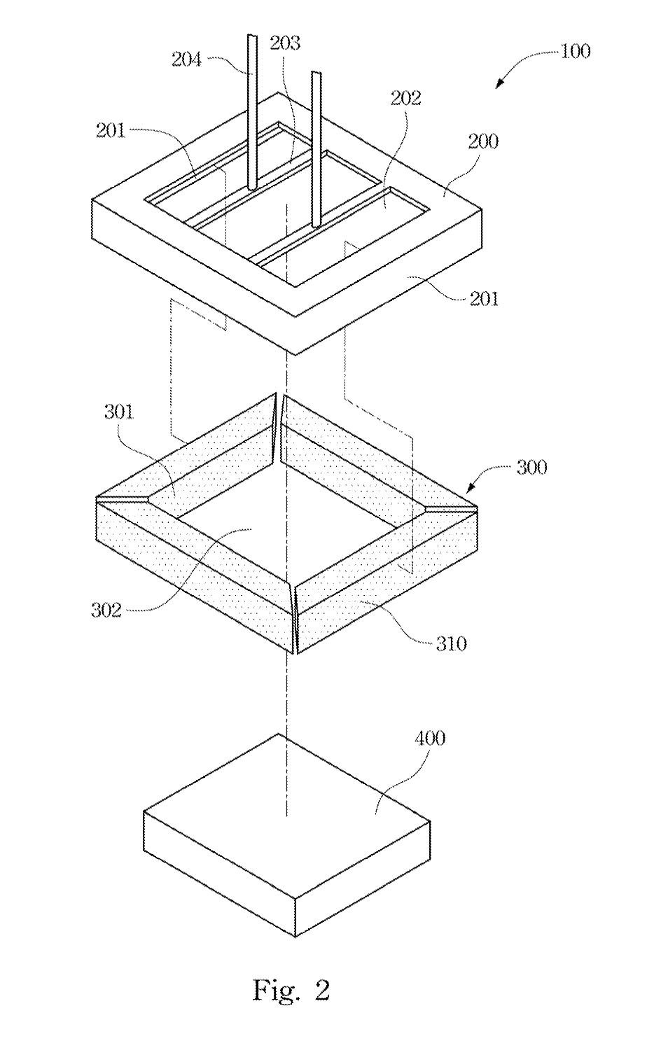

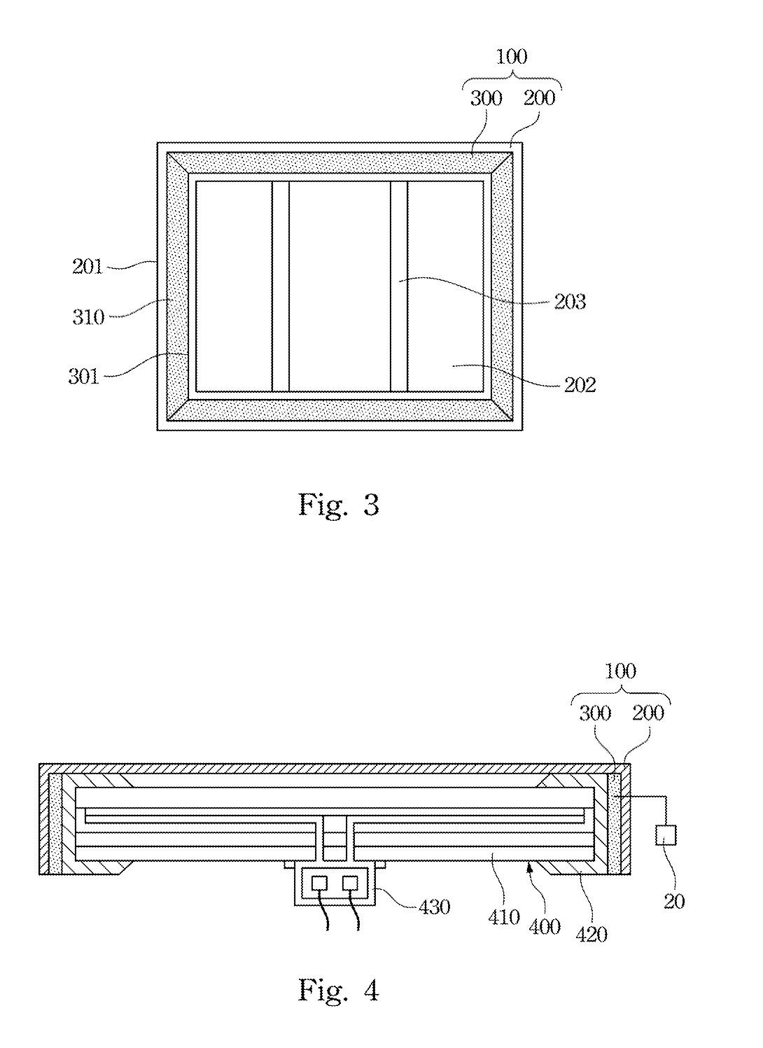

Refer to FIG. 2 and FIG. 3 in which FIG. 2 illustrates a disassembling view of an electrical insulation test apparatus with a photovoltaic panel according to one embodiment of the present invention, and FIG. 3 illustrates a bottom view of the electrical insulation test apparatus in FIG. 2. The electrical insulation test apparatus 100 is provided for testing electric conductivity of a photovoltaic panel 400. The electrical insulation test apparatus 100 includes a conductive and deformable member and an electric conductivity testing device electrically connected the conductive and deformable member. The conductive and deformable member, for example, can be a conductive cushion 300, at least possesses deformable and electrically conductive characteristics for surrounding the tested photovoltaic panel 400 to be deformed to substantially fit the size of the tested photovoltaic panel 400 so as to contact all peripheral surfaces of the tested photovoltaic panel completely. The electric conductivity testing device detects whether at least one of the peripheral surfaces of the tested photovoltaic panel 400 is electrically conducted with the conductive and deformable member or not.

In details, the electrical insulation test apparatus 100 further has a cap 200. The cap 200 has some protruding edges 201 and an indentation 202. The protruding edges 201 extend outwards from one side of the cap 200, and the indentation 202 is surrounded by the inner sidewalls of the protruding edges 201. The conductive cushion 300 couples to the inner sidewalls of the protruding edges 201 in the indentation 202. Also, the conductive cushion 300 has a receiving space 302 having a size substantially fit to a size of the tested photovoltaic panel 400, for receiving the tested photovoltaic panel 400.

In the embodiment, the cap 200 can be rigid enough so that the cap 200 is not easy to be bended while the tested photovoltaic panel 400 is moved in the receiving space 202. Thus, the rigid cap 200 further helps the conductive cushion 300 to contact with the peripheral surfaces of the tested photovoltaic panel 400 tightly. For example, the cap 200 could be made of metal, plastic, glass or wood.

In practice, the conductive cushion 300 can be provided by assembly or integrally forming. When the conductive cushion 300 is assembled with a plurality of components 310, each component 310 couples to one inner sidewall of the protruding edge 201. When the conductive cushion 300 is formed integrally in one piece, the conductive cushion 300 is shaped as a rectangular ring. For example, the conductive cushion 300 could be made of conductive foam, conductive gel, conductive adhesive or conductive resin.

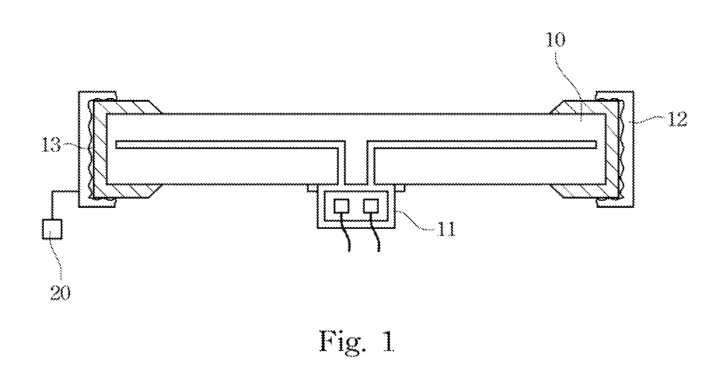

In addition, refer to FIG. 1 again, since the tested photovoltaic panel 400 normally presents as a rectangular shape, thus, the cap 200 can be presented as a rectangular shape or the receiving space 302 of the conductive cushion 300 can be presented as a rectangular shape for receiving the tested photovoltaic panel 400.

Refer to FIG. 4 in which FIG. 4 illustrates a cross-sectional view of the electrical insulation test apparatus according to another embodiment of the present invention. A photovoltaic panel 400 mainly includes a glass body 410, some gaskets 420 and a junction box 430. The glass body 410 includes some layers tacked together. These gaskets 420 are sealed on the peripheral surfaces of the glass body 410, respectively. The junction box 430 electrically connects with an interior of the glass body 410.

Refer to FIG. 1 and FIG. 4 again. In operation, when a photovoltaic panel 400 is located on a platform (not shown), the electrical insulation test apparatus 100 can be moved to cover the photovoltaic panel 400 manually by manpower, or automatically by for example, a movable arm 204 physically connected with a connection 203 of the cap 200, so that the photovoltaic panel 400 is moved in the receiving space 302.

Thus, when the photovoltaic panel 400 is moved in the receiving space 302, since the size of the photovoltaic panel 400 is larger in an acceptable range or exactly the same to the size of the receiving space 302, the conductive cushion 300 can be deformed to fit the photovoltaic panel 400 to contact the surfaces of the gaskets 420 of the photovoltaic panel 400, so that all of the inner surfaces 301 of the conductive cushion 300 can contact with all of the peripheral surfaces of the photovoltaic panel 400 completely. After that, an electric conductivity testing device 20 is provided to electrically connect with the conductive cushion 300 before the junction box 430 is electrically conducted with the interior of the photovoltaic panel 400 for detecting whether the peripheral surfaces of the tested photovoltaic panel 400 electrically conducts electric power to the conductive cushion 300 or not.

If the electric conductivity testing device 20 can be electrically conducted from the gaskets 420 of the photovoltaic panel 400 via the conductive cushion 300, electric leakages might occur from one of the gaskets 420 of the photovoltaic panel 400; otherwise, if the electric conductivity testing device 20 cannot be electrically conducted from the gaskets 420 of the photovoltaic panel 400 via the conductive cushion 300, the gaskets 420 of the photovoltaic panel 400 are electrically insulated from the interior of the photovoltaic panel 100.

To be noted, (1) the size of the photovoltaic panel 400 can be larger than the receiving space 302 in an acceptable range as long as the conductive cushion 300 still can be deformed for receiving the photovoltaic panel 400; (2) the conductive cushion, in reality, could contact with the peripheral surfaces of the tested photovoltaic panel as completely as possible; (3) as long as the cap is unable to be bended while the tested photovoltaic panel is moved in the receiving space 302, the hardness of the cap is not limited particularly.

To sum up, in the electrical insulation test apparatus of the present invention, since the conductive and deformable member can be deformed to fit the size of the tested photovoltaic panel, all peripheral surfaces of the tested photovoltaic panel can be contacted by the conductive and deformable member as completely as possible.

Therefore, the result of the electrical insulation test might be much more correct. In addition, unlike wrapping conductive foil papers, the electrical insulation test apparatus is reusable in testing electric conductivity of the photovoltaic panels so as to decrease the material costs and the labor costs, and will not damage the surface of the electrical insulation test apparatus by scratch.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An electrical insulation test apparatus for testing electric conductivity of a photovoltaic panel, comprising:
a cap having an indentation at one side thereof; and
a conductive cushion being deformable, and installed in the indentation, and having a receiving space substantially sized to fit a size of the tested photovoltaic panel.

2. The electrical insulation test apparatus according to claim 1, wherein the cap is unable to be bended while the tested photovoltaic panel is moved in the receiving space.

3. The electrical insulation test apparatus according to claim 2, wherein the cap is made of metal, plastic, glass or wood.

4. The electrical insulation test apparatus according to claim 1, wherein the cap is presented as a rectangular shape.

5. The electrical insulation test apparatus according to claim 1, wherein the receiving space of the conductive cushion is presented as a rectangular shape.

6. The electrical insulation test apparatus according to claim 1, wherein the conductive cushion is formed integrally in one piece.

7. The electrical insulation test apparatus according to claim 6, wherein the conductive cushion is presented as a rectangular ring.

8. The electrical insulation test apparatus according to claim 1, wherein the conductive cushion comprises a plurality of components assembled together.

9. The electrical insulation test apparatus according to claim 1, wherein the conductive cushion is a conductive foam, a conductive gel, a conductive adhesive or a conductive resin.

10. The electrical insulation test apparatus according to claim 1, further comprising an electric conductivity testing device electrically connected with the conductive cushion.

11. The electrical insulation test apparatus according to claim 1, wherein the cap has a plurality of inner sidewalls surrounding the indentation thereof, and the conductive cushion is coupled to the inner sidewalls of the cap.

12. The electrical insulation test apparatus according to claim 1, further comprising a movable arm physically connected with the cap.

13. An electrical insulation test apparatus for testing electric conductivity of a photovoltaic panel, comprising:
a conductive and deformable member, operable for surrounding the tested photovoltaic panel to being deformed to fit the size of the tested photovoltaic panel so as to completely contact all peripheral surfaces of the tested photovoltaic panel, and
an electric conductivity testing device electrically connected with the conductive and deformable member, for detecting whether one of the peripheral surfaces of the tested photovoltaic panel is electrically conducted with the conductive and deformable member.

14. The electrical insulation test apparatus according to claim 13, wherein the conductive and deformable member is made of a conductive foam, a conductive gel, a conductive adhesive or a conductive resin.

15. The electrical insulation test apparatus according to claim 13, wherein the conductive and deformable member having a receiving space substantially sized to fit a size of the tested photovoltaic panel.

16. The electrical insulation lest apparatus according to claim 15, further comprising:
a cap having an indentation at one side thereof, wherein the conductive and deformable member is installed in the indentation thereof and carried by the cap.

17. The electrical insulation test apparatus according to claim 16, wherein the cap is unable to be bended while the tested photovoltaic panel is moved in the receiving space.

18. The electrical insulation test apparatus according to claim 17, wherein the cap is made of metal, plastic, glass or wood.

19. The electrical insulation test apparatus according to claim 13, further comprising an electric conductivity testing device electrically connected with the conductive and deformable member.
